(19) United States
(12) Patent Application Publication
(10) Pub. No.: US 2016/0227010 A1
(43) Pub. Date: Aug. 4, 2016

(54) DEVICE AND METHOD FOR PROVIDING LOCK SCREEN

(71) Applicant: SAMSUNG ELECTRONICS CO., LTD., Suwon-si, Gyeonggi-do (KR)

(72) Inventors: Jong-Woo JUNG, Hwaseong-si (KR); In-Sik MYUNG, Incheon (KR); Sahng-Hee BAHN, Yongin-si (KR); Jung-Won LEE, Seoul (KR)

(21) Appl. No.: 15/021,826

(22) PCT Filed: Sep. 15, 2014
(86) PCT No.: PCT/KR2014/008581

§ 371 Date: Mar. 14, 2016

(30) Foreign Application Priority Data
Sep. 13, 2013 (KR) 10-2013-0110451

(51) Int. Cl. H04M 1/673; H04M 1/247; H04M 1/725

(52) U.S. Cl. CPC H04M 1/673; H04M 1/72583; H04M 1/2477; H04M 2250/22

(57) ABSTRACT

A method for enabling a display of application-related information and execution of a corresponding application, on a lock screen is provided. The method includes displaying a lock screen including a region in which a plurality of executable objects are arranged and an information display region having a restricted viewing range with respect to the plurality of executable objects, when user input for activation of a portable device is detected, and changing the information according to the user input and displaying the changed information or executing the application of the corresponding executable object. Thus, the method enables a user to confirm the plurality of executable objects and the information related to the plurality of executable objects by showing the plurality of executable objects and the outline information related to the plurality of objects on the lock screen, and can provide an intuitive user experience (UX) by providing the lock screen.

### CROSS-REFERENCE TO RELATED APPLICATION(S)

This application is a U.S. National Stage application under 35 U.S.C. §371 of an International application filed on Sep. 15, 2014 and assigned application number PCT/KR2014/008581, which claimed the benefit of a Korean patent application filed on Sep. 13, 2013 in the Korean Intellectual Property Office and assigned Serial number 10-2013-0110451, the entire disclosure of each of which is hereby incorporated by reference.

### TECHNICAL FIELD

The present disclosure relates to a device and method for displaying application-related information and executing the application on a lock screen.

### BACKGROUND

With the rapid development of communication technologies, the number of functions of a portable device is increasing, and accordingly, various user interfaces (UIs) and various functions using such UIs are being developed.

In particular, a portable device with a touch screen has a lock/unlock function to limit unnecessary input errors in a standby state or to prevent other people from using the portable device, wherein the lock/unlock function is based on various methods. Generally, the portable device can perform the lock function when the lock function was set in advance by a user.

The portable device in which the lock function was set activates the lock function when no user input is received for a predetermined time. That is, when a user makes no input for a predetermined time while using a specific function of the portable device, the portable device deactivates the screen or function to enter a lock state. In the lock state, the screen of the portable device is turned off or a predetermined image is displayed.

Meanwhile, along with an increase in diversity of user demands, a need for more efficiently using the screen space of the portable device is increasing. Accordingly, in order to raise the effective value of the lock screen of the portable device while satisfying such various user demands, in addition to limiting touch input errors and restricting access, a method for combining various services of the portable device with additional functions is needed. Also, user convenience needs to be a high priority in implementing the method.

The portable device activates the lock function whenever a user input waiting time elapses. Generally, the portable device releases a lock mode, for example, a touch screen hold state, according to a pre-defined method. After the lock mode is released, a home screen or a recently used application is displayed. Therefore, if the user wants to use a specific function when the portable device is in a locked state or in a deactivated state, the user needs to release the lock mode using a predetermined lock release method, and then perform a procedure for entering a menu for executing the function, which causes the user's burden or inconvenience. For this reason, a method for easily releasing locking while performing user authentication is needed.

Also, the portable device needs to raise visibility for information transfer by expressing information in various ways while providing the user with a new and pleasant interface, instead of focusing on limiting any unnecessary touch input and displaying a screen for receiving a lock release comman.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a device and method for enabling a user to conveniently release a lock function of a portable device.

Another aspect of the present disclosure is to provide a device and method for quickly and effectively executing applications linked to objects displayed on a lock screen.

Another aspect of the present disclosure provide a device and method for displaying a lock screen in such a way to enhance visibility with respect to objects executable on a portable device and information related to the objects.

Another aspect of the present disclosure provide a device and method for displaying a lock screen using a 3 dimensional (3D) computer graphics user interface.

In accordance with an aspect of the present disclosure, a method of providing a lock screen in a portable device is provided. The method includes detecting a user input for activating the portable device, and displaying, if the user input is detected, a lock screen configured with a plurality of executable objects and an information display area having a restricted viewing range with respect to at least one executable object of the plurality of executable objects.

In accordance with another aspect of the present disclosure, a portable device for providing a lock screen is provided. The portable device includes a controller configured to control, if a user input for activating the portable device is detected, a display of a lock screen including at least one executable object and restricted information having a restricted viewing range among information about the executable object, and a display unit configured to display the lock screen.

In accordance with another aspect of the present disclosure, by arranging executable objects and information related to the executable objects on a lock screen of a portable device, it is possible to use a screen efficiently so that a user can easily check executable objects and information related to the executable objects.

In accordance with another aspect of the present disclosure, by unlocking the locked state of the portable device while quickly executing a specific application, it is possible to improve the convenience in use of the portable device.

In accordance with another aspect of the present disclosure, by providing interaction for quickly executing an application on the lock screen of the portable device, and displaying the application-related information with a differentiated level in order to prevent other peoples except for an owner of the portable device from accessing personal information of the application, it is possible to protect the owner's privacy.

In accordance with another aspect of the present disclosure, by providing the lock screen with various effects changing according to the user's input, it is possible to provide the user with an intuitive and sensitive user experience (UX).

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block configuration diagram of a portable device according to an embodiment of the present disclosure;

FIG. 2 is a flowchart illustrating an embodiment of a method of providing a lock screen in a portable device according to an embodiment of the present disclosure;

FIGS. 3A to 3D are views for describing a method of changing a display screen of a portable device according to an embodiment of the present disclosure;

FIGS. 4A to 4D are views for describing a method of changing a display screen of a portable device according to an embodiment of the present disclosure;

FIG. 5 is a flowchart detailedly illustrating an embodiment of a method of providing a lock screen in a portable device according to an embodiment of the present disclosure;

FIG. 6 is a view for describing a configuration of a lock screen according to an embodiment of the present disclosure;

FIGS. 7A to 7C are views for describing a method of changing a display of object information on a lock screen, according to an embodiment of the present disclosure;

FIGS. 8 to 13 show configuration examples of lock screens according to various applications, according to various embodiments of the present disclosure;

FIGS. 14A and 14B show examples of screens for describing an interaction method for outputting a lock screen in a screen-off state, according to an embodiment of the present disclosure; and

FIG. 15 shows examples of screens for describing an interaction method for outputting a lock screen in a screen-off state, according to another embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terminology used herein is for the purpose of describing embodiments only and is not intended to be limiting of the embodiments. As used herein, the singular forms are intended to include the plural forms as well, unless the context clearly indicates otherwise. It will be further understood that the terms “comprises” and/or “has” when used in this specification, specify the presence of stated feature, number, operation, component, element, or a combination thereof but do not preclude the presence or addition of one or more other features, numbers, operations, components, elements, or combinations thereo.

The terms used herein, including technical and scientific terms, have the same meanings as terms that are generally understood by those skilled in the art, as long as the terms are not differently defined. It should be understood that terms defined in a generally-used dictionary have meanings coinciding with those of terms in the related technology. As long as the terms are not defined obviously, they are not ideally or excessively analyzed as formal meanings.

According to various embodiments of the present disclosure, there is provided a method for displaying application-related information and executing the application on a lock screen. The method may include: displaying, if a user input for activating a portable device is detected, a lock screen configured with an area in which a plurality of executable objects are arranged and an information display area having a restricted viewing range with respect to each object, and changing and displaying the information or executing an application of the corresponding object, according to a user input. As such, by showing executable objects and outline information related to the objects on a lock screen, a user can easily check the executable objects and the outline information related to the object. Also, by providing the lock screen with various effects changing according to a user input, it is possible to provide the user with an intuitive and sensitive user experience (UX).

The portable device may be an arbitrary device having a touch screen, and the portable device may be also called a mobile terminal, a communication terminal, a portable communication terminal, a portable mobile terminal, and the like.

For example, the portable device may be a smart phone, a mobile phone, a game, television (TV), a display device, a vehicle head unit, a notebook computer, a laptop computer, a tablet computer, personal media player (PMP), personal digital assistants (PDA), or the like. Also, the portable device may be implemented as a pocket-sized portable communication terminal having a wireless communication function. Also, the portable device may be a flexible display device.

A representative one of the above-mentioned portable devices is a mobile phone, and some of components included in such a portable device may be omitted or changed as necessary.

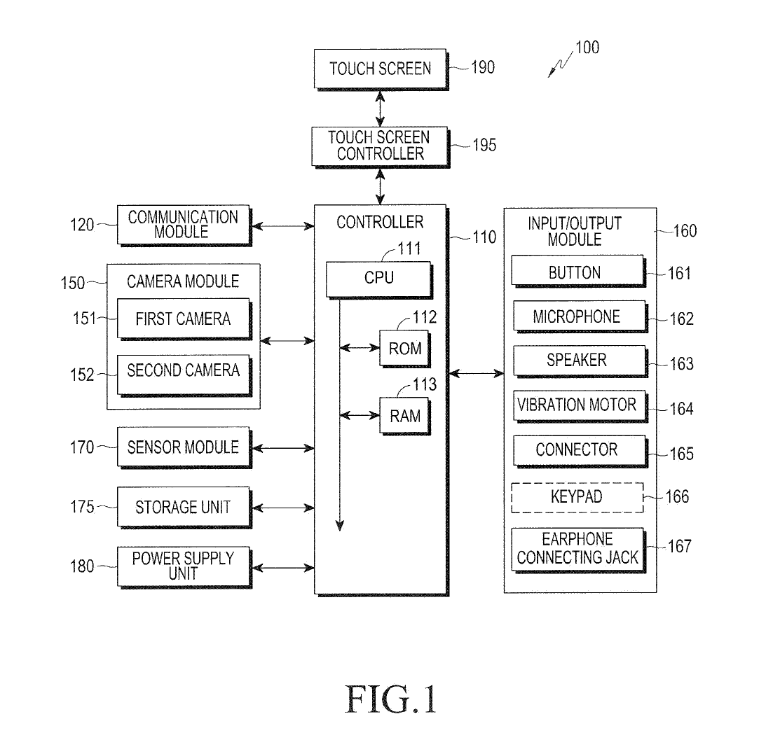

FIG. 1 is a block configuration diagram of a portable device according to an embodiment of the present disclosure.

Referring to FIG. 1, a portable device 100 may connect to an external electronic device (not shown) using at least one of a communication module 120, a connector 165, and an earphone connecting jack 167. The external electronic device may include an earphone, an external speaker, a universal serial bus (USB) memory, a battery charger, a cradle/dock, a digital multimedia broadcasting (DMB) antenna, a mobile payment system, healthcare equipment (a blood glucose meter, etc.), a game, a vehicle navigation system, and the like, which can be removably connected to the portable device 100 through a line. Also, the portable device 100 may include a Bluetooth communication apparatus, a near field communication (NFC) apparatus, a Wi-Fi direct communication apparatus, a wireless access point (WAP), and the like, which can be connected to the external electronic device in a wireless fashion. Also, the portable device 100 may be connected to another portable device or electronic device (for example, a mobile phone, a smart phone, a tablet personal computer (PC), a desktop PC, and a server) in a wired/wireless fashion.

Referring to FIG. 1, the portable device 100 may include at least one touch screen 190 and at least one touch screen controller 195. In the following description, a display unit and a display controller are assumed to be the touch screen 190 and the touch screen controller 195, respectively. Also, the portable device 100 may include a controller 110, a communication module 120, a camera module 150, an input/output module 160, a sensor module 170, a storage unit 175, and a power supply unit 180.

The controller 110 may include a central processing unit (CPU) 111, a read only memory (ROM) 112 that stores control programs for controlling the portable device 100, and a random access memory (RAM) 113 that stores signals or data received from the outside or is used as a memory area for tasks being performed by the portable device 100. The CPU 111 may include a single core, a dual core, a triple core, or a quad core. The CPU 111, ROM 112, and RAM 113 may be connected to each other through internal buses.

Also, the controller 110 may control the communication module 120, the camera module 150, the input/output module 160, the sensor module 170, the storage unit 175, the power supply unit 180, the touch screen 190, and the touch screen controller 195.

Also, the controller 110 may control object-related operation on a lock screen that is configured with a plurality of executable graphic objects or graphic items and information related to the objects on the touch screen 190.

In detail, the controller 110 may sense a user input for activation, such as operation of pressing a home button or operation of making a user gesture, when the portable device 100 is in a deactivated state, that is, in an off-screen state. Then, the controller 110 may display a lock screen configured with an area in which a plurality of executable objects are arranged and an information display area having a restricted viewing range with respect to each object. If a user input is detected on the information display area when the lock screen is displayed, the controller 110 may change and display information according to the user input, and if a user input is detected on the area in which the objects are arranged, the controller 110 may execute an application linked to an object to which the user input is applied. According to the present disclosure, there is provided a lock screen on which one or more applications are arranged so that other people as well as the owner of the portable device 100 can use some of functions of the applications.

In the current embodiment, the lock screen may be a screen that is displayed before the lock function is released in a screen-off state. The lock screen may be different from a lock release screen for receiving a lock release command according to one of various locking methods, such as a pattern input method, a personal identification number (PIN) input method, a password input method, etc. The lock screen according to the present disclosure is also called a glance view screen. On the glace view screen, a plurality of executable objects and outline information related to the objects may be displayed. Information related to objects may be classified according to level. For example, information related to objects may be classified into a primary level and a secondary level. For example, information of the primary level may be information that is irrelevant to leakage of personal information, and information of the secondary level may be information with content related to personal information.

Accordingly, in an embodiment of the present disclosure, when a user does not want leakage of personal information stored in the portable device 100 or unauthorized use of the portable device 100 by other people, the user can set a range of information that is displayed on the lock screen such that only information of the primary level is displayed on the lock screen. Also, according to an embodiment of the present disclosure, when a command for executing one of the plurality of executable objects is received, a lock release screen requesting a user to input a lock release command may be displayed in order to prevent unauthorized use of the portable device 100 by other people. That is, by performing user authentication before an application related to the selected object is executed, it is possible to allow a user to easily access desired information on the lock screen, while preventing other people except for the owner of the portable device 100 from accessing personal information of the application.

Also, the controller 110 may detect a user input when a plurality of objects or items are displayed on the touch screen 190, wherein the user input may be a touch input of touching an object with touchable user input means such as an input unit or the user's finger, a gesture input of making the touchable user input means approach the object, or a gesture input of locating the touchable user input means close to the object. Then, the controller 110 may identify the object corresponding to a location at which the user input is made on the touch screen 190. The user input made on the touch screen 190 may be one of a direct touch input of directly touching the object, and a hovering input which is an indirect touch input of approaching the object within a predetermined distance to the object without directly touching the object. For example, if a user locates the user input means close to the touch screen 190, an object located near the user input means may be selected. Herein, the user input may be a switch/button input through the button 161 or the keypad 166, a voice input through the microphone 162, etc., as well as a user input through the touch screen 190.

The object or item (or a function item) may be at least one of an application, a menu, document, a widget, a picture, video, E-mail, a short message service (SMS) message, and a multimedia messaging service (MMS) message, which have been or can be displayed on the touch screen 190 of the portable device 100, and the object or item can be created, selected, executed, deleted, canceled, stored, or changed by the user input device. The object or item may be a button, an icon (or a shortcut icon), a thumbnail image, or a folder that stores at least one object in a portable device. Also, the object or item may be displayed in the form of an image, text, etc. The shortcut item is an image that is displayed on the touch screen 190 of the portable device 100 to quickly execute a call, a contact list, a menu, etc., which are basically provided by each application or by the portable device 100, and if a command or selection for executing the shortcut item is received, the corresponding application is executed.

As such, the plurality of executable objects that are displayed on the lock screen according to the embodiment of the present disclosure may include at least one among shortcut icons for executing applications, widgets, icons representing documents with specific file formats, pictures, and folders.

For example, the user may himself/herself draw an image, text, etc. to create a unique object or item. The user may set such a personalized object or item as the unique object or item to be linked to a desired application so that only himself/herself can know what application the object or item is linked to. Accordingly, a hidden method of preventing other people from knowing purposes of a personalized object displayed on the lock screen can be implemented to thereby provide a personalized lock screen.

Also, the controller 110 may detect a user input event such as a hovering event of making user input means such as a finger approach the touch screen 190 or of locating the user input means close to the touch screen 190.

If a user input event occurs with respect to a predetermined item or according to a predetermined method, the controller 110 may perform predetermined program operation corresponding to the user input event. According to an embodiment, if a request for displaying a lock screen on which a plurality of executable objects are arranged is received, the controller 110 may display content related to a recently occurred event on the lock screen. If the recently occurred event is a missed call, information about the missed call may be displayed on the lock screen, together with a call application related to the missed call.

At this time, according to the user's setting, outline information that is irrelevant to leakage of personal information, for example, a part of a phone number of the other party who made the missed call, may be displayed on the lock screen. If the user takes a gesture of turning the current page to the next page with the input means when the information about the missed call is displayed, the information may be changed to another information. Meanwhile, if the user selects the information about the missed call, the call application may be directly executed to call the other party who made the missed call. As such, according to the present disclosure, the user can easily check an executable object and related information through the lock screen so as to directly execute a desired application.

The communication module 120 may include at least one of a mobile communication module, a wireless local area network (WLAN) module, and a short-range communication module.

The mobile communication module may enable the portable device 100 to connect to an external device through mobile communication using at least one or a plurality of antennas (not shown), under the control of the controller 110. The mobile communication module may transmit/receive radio signals for a voice call, a video call, an SMS message, or an MMS message to/from a mobile phone (not shown), a smart phone (not shown), a tablet PC (not shown), or another electronic device (not shown) when the corresponding phone number is input to the portable device 100.

The WLAN module may be connected to the Internet through a WAP, under the control of the controller 110. The WLAN module 131 may support the IEEE802.11x standard.

The short-range communication module may perform short-range communication between the portable device 100 and an external electronic device in a wireless fashion under the control of the controller 110. The short-range communication may include Bluetooth, infrared data association (IrDA), Wi-Fidirect communication, NFC, and the like.

The camera module 150 may include at least one of first and second cameras 151 and 152 for photographing still images or moving images under the control of the controller 110. The first camera 151 may be disposed in the front side of the portable device 100, and the second camera 152 may be disposed in the rear side of the portable device 100. The camera module 150 may function to photograph a user input such as a user gesture for activating the portable device 100. For example, if the user input means approaches the portable device 100 so that a proximity event is detected, the camera module 150 may be activated to acquire an image. The image may be used to recognize the user gesture, so that predetermined program operation (for example, execution of a predetermined object displayed on the lock screen) may be performed in correspondence to the recognized user gesture.

The input/output module 160 may include at least one among at least one button 161, at least one microphone 162, at least one speaker 163, at least one vibration motor 164, a connector 165, the keypad 166, and the earphone connecting jack 167. However, the input/output module 160 is not limited to the above-mentioned devices, and a cursor control, such as a mouse, a trackball, a joystick, or cursor direction keys, may be provided to control the movement of a cursor on the touch screen 190.

The button 161 may be formed on the front, side, or rear surface of the housing (or case) of the portable device 100, and may include at least one among a power/lock button, a volume button, a menu button, a home button, a back button, and a search button. For example, if the home button is pressed in a deactivated state in which the screen is off, a user input for activating the screen may be detected so that the lock screen may be displayed.

The microphone 162 may receive a voice or sound under the control of the controller 110 to generate an electrical signal. For example, the microphone 162 may receive a user voice for displaying the lock screen.

The speaker 163 may output sound corresponding to various signals or data (for example, radio data, broadcasting data, digital audio data, digital video data, etc.) to the outside of the portable device 100, under the control of the controller 110. The speaker 163 may output sound (for example, button manipulation sound corresponding to a call, ring back tone, the other party's voice, etc.) corresponding to a function that is performed by the portable device 100. There may be provided one or more speakers 163 at one or more appropriate locations on the housing of the portable device 100. According to an embodiment, the speaker 163 may function to aurally inform information displayed on the lock screen. Accordingly, if a user input for activating the portable device 100 is detected, the off screen may be converted to the lock screen, and then information displayed on the lock screen may be output as sound.

For example, if the lock screen has been set to inform weather information, an image and weather information representing a weather condition, such as rainy, cloudy, sunny, and snowy, may be displayed on the lock screen, while outputting a predetermined sound effect corresponding to the weather condition. If the lock screen has been set to display stock information, the upper limit prices, the lower limit prices, etc. may be output as a sound effect. Also, if the lock screen has been set to display sports information, information about wins, ties, and losses of a team which the user cheers for may be output as different sound effects. Also, if the lock screen has been set to display traffic information, information about traffic situations of frequently used roads may be output as a sound effect. As such, according to an embodiment of the present disclosure, by providing various aural effects according to the kind of information displayed on the lock screen, it is possible to provide the user with an intuitive and sensitive UX.

The vibration motor 164 may convert an electrical signal into mechanical vibration under the control of the controller 110. For example, if a voice or video call is made by another device (not shown) when the portable device 100 is in a vibration mode, the vibration motor 164 may operate. There may be provided one or more vibration motors 164 in the housing of the portable device 100. The vibration motor 164 may operate in correspondence to a user input through the touch screen 190. According to an embodiment of the present disclosure, various visual effects varying according to the kind of information displayed on the lock screen may be provided with aural effects through the speaker 163, and also may be provided with tactile effects by differentiating vibration levels through the vibration motor 164.

The connector 165 may be used as an interface for connecting the portable device 100 to an external electronic device or a power source (not shown). The controller 110 may transmit data stored in the storage unit 175 of the portable device 100 to an external electronic device or receive data from the external electronic device through a wired cable connected to the connector 165. The portable device 100 may receive power from a power source or charge its battery using the power source through the wired cable connected to the connector 165.

The keypad 166 may receive a key input from a user to control the portable device 100. The keypad 166 may include a physical keypad (not shown) formed on the portable device 100 or a virtual keypad (not shown) displayed on the touch screen 190. The physical keypad formed on the portable device 100 may be excluded according to the performance or structure of the portable device 100.

The earphone (not shown) may be inserted into the earphone connecting jack 167 to connect to the portable device 100.

According to an embodiment of the present disclosure, if an external device is inserted into the earphone connecting jack 167 or the connector 165 of the portable device 100 to be connected to electrodes formed inside the portable device 100, the controller 110 may determine that the external device was connected in a wired fashion. Also, if the portable device 100 is connected to an external device through the sub communication module 130 in a wireless fashion (for example, through WLAN, Bluetooth, or NFC), the controller 110 may determine that the external device was connected in a wireless fashion. Before the external device is connected to the portable device 100, the touch screen 190 of the portable device 100 may be in a deactivated state in which the screen is off. Accordingly, if the controller 110 senses a connection to an external device, the controller 110 may display a lock screen on which an object representing an application that can be used through the connected external device is displayed together with information related to the object. Alternatively, if the controller 110 senses a connection to an external device, the controller 110 may extract a list of available personalized applications, and display a lock screen on which objects corresponding to the list of the available personalized applications are displayed together with information related to the objects.

The sensor module 170 may include at least one sensor for detecting the state of the portable device 100 and a situation around the portable device 100. For example, the sensor module 170 may include at least one sensor among a proximity sensor (not shown) for detecting an approach to the portable device 100, an ambient light sensor (not shown) for detecting the ambient light intensity around the portable device 100, a motion sensor (not shown) for detecting a motion (for example, rotation, acceleration, vibration) of the portable device 100, a geo-magnetic sensor (not shown) for detecting a point of the compass of the portable device 100 using the earth's magnetic field, a gravity sensor (not shown) for detecting a direction in which gravity is applied, an altimeter (not shown) for measuring atmospheric pressure to detect an altitude, and a global positioning system (GPS) module. As such, the sensor module 170 according to an embodiment of the present disclosure may function to detect a user input such as a user gesture for activating the portable device 100.

The storage unit 175 may store signals or data that is input/output according to the operation of the communication module 120, the camera module 150, the input/output module 160, the sensor module 170, or the touch screen 190, under the control of the controller 110. The storage unit 175 may store applications and control programs for controlling the portable device 100 or the controller 110.

The term “storage unit” indicates an arbitrary data storage device, such as the storage unit 175, the ROM 112 and RAM 113 in the controller 110, a memory card (for example, a secure digital (SD) card or a memory stick) installed in the portable device 100, and the like. The storage unit 175 may include a non-volatile memory, a volatile memory, a hard disk drive (HDD), and a solid state drive (SSD).

Also, the storage unit 175 may store applications with various functions, such as navigation, a video call, games, a time-based alarm application, etc., images for providing a user with graphical user interfaces (GUIs) associated with the applications, user information, document, databases or data related to a method of processing touch inputs, background images (a menu screen, a lock screen, etc.) or operation programs required to drive the portable device 100, images photographed by the camera module 150, etc.

Also, the storage unit 175 may store a plurality of objects that can be used to configure a lock screen, and information that is displayed with respect to the objects. Also, the storage unit 175 may store data created to apply 3 dimensional (3D) graphics effects to the lock screen. The information that is displayed with respect to the objects may be largely classified into primary level information that is irrelevant to leakage of personal information and secondary level information related to personal information.

Herein, the primary level information may be information subjected to a process of abstracting or simplifying information to show only a part of the information such that only the owner of the portable device 100 can recognize the information. For example, the primary level information may be a part of a picture in the case of a gallery application, the last digits of a phone number in the case of an address book application, or a message including no information about a sender in the case of a social networking service (SNS) application. In this case, second level information corresponding to the primary level information may be the entire of the picture, all digits of the phone number, or a message including the information about the sender.

Like the information classified into the primary and secondary levels, information for executing only a part of the functions of the applications of the objects displayed on the lock screen on the lock screen may be stored. For example, in the case of a calendar application, an empty calendar may be displayed on the lock screen, and if a calendar application execution command is received after the lock screen is released, a screen on which schedule information for details according to date is displayed may be displayed. Also, in the case of a camera application, the storage unit 175 may store data required for outputting a lock screen allowing only photographing. Also, in the case of a memo application, the storage unit 175 may store data required for outputting a lock screen displaying an empty memo instead of a real memo in order to allow a user to draw a new memo.

The storage unit 175 is machine (for example, a computer)-readable media, and the term “machine-readable media” can be defined as media of providing data to a machine so that the machine can perform a specific function. The storage unit 175 may include non-volatile media and volatile media. The media should be a tangible device so that commands transferred by the media can be detected by a physical device for reading the commands through a machin.

The machine-readable media may include at least one among a floppy disk, a flexible disk, a hard disk, a magnetic tape, a compact disc ROM (CD-ROM), an optical disk, a punch card, a paper tape, a RAM, a programmable ROM (PROM), an erasable PROM (EPROM), and a FLASH-EPROM, however, the machine-readable media is not limited to the above-mentioned devices.

The power supply unit 180 may supply power to one or more batteries installed in the housing of the portable device 100 under the control of the controller 110. The one or more batteries may supply power to the portable device 100. Also, the power supply unit 180 may supply power received from an external power source to the portable device 100 through a wired cable connected to the connector 165. Also, the power supply unit 180 may supply power received wirelessly from an external power source to the portable device 100 through wireless charging technology.

Also, the portable device 100 may include at least one touch screen 190 that provides a user with GUIs corresponding to various services (for example, a call, data transmission, and photographing.

The touch screen 190 may output an analog signal corresponding to at least one user input inputted to a GUI to the touch screen controller 195. The touch screen 190 may receive at least one user input through a user's body part (for example, a finger including a thumb) or the input unit (for example, a stylus pen or an electronic pen). Also, the touch screen 190 may sense a touch-and-drag operation. In this case, the touch screen 190 may transfer an analog signal corresponding to a touch trajectory according to the touch-and-drag operation to the touch screen controller 195.

In this specification, the “touch” is not limited to a contact of a finger or the input unit to the touch screen 190, and may include non-contact recognition (for example, when a user input device is located within a recognition distance (for example, 1 cm) in which the user input device can be detected without a direct contact to the touch screen 190). The recognition distance in which the touch screen 190 can recognize the user input device depends on the performance or structure of the portable device 100. Particularly, in order for the touch screen 190 to distinguish a direct-touch event generated by a direct-contact with a user input device from an indirect-touch event (that is, a hovering event), the touch screen 190 may be configured to output different values (for example, analog values including voltage values and current values) according to the direct-touch event and the hovering event.

The touch screen 190 may be a resistive touch screen, a capacitive touch screen, an infrared touch screen, an acoustic wave touch screen, or their combination.

The touch screen controller 195 may convert an analog signal received from the touch screen 190 into a digital signal, and transfer the digital signal to the controller 110. The controller 110 may control the touch screen 190 using the digital signal received from the touch screen controller 195. For example, the controller 110 may select or execute a shortcut icon or an object displayed on the touch screen 190 in response to a direct-touch event or a hovering event. Also, the touch screen controller 195 may be integrated into the controller 110.

The touch screen controller 195 may detect a value (for example, a current value) output through the touch screen 190 to determine an hovering interval or distance as well as a user's input location, convert the determined distance value into a digital signal (for example, a z coordinate), and then provide the digital signal to the controller 110. Also, the controller 110 may detect various user inputs that are received through the camera module 150, the input/output module 160, and the sensor module 170, as well as the touch screen 190. The user inputs may include various kinds of information that is input to the portable device 100, such as a user's gesture, voice, movement of pupil, bio signals, and the like. The controller 110 may control the portable device 100 to perform a predetermined operation or function corresponding to the detected user input.

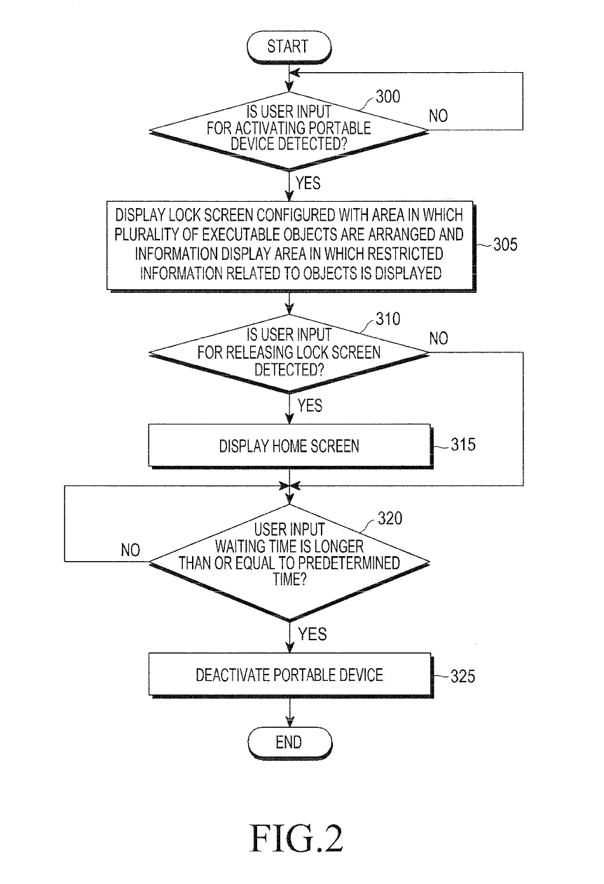

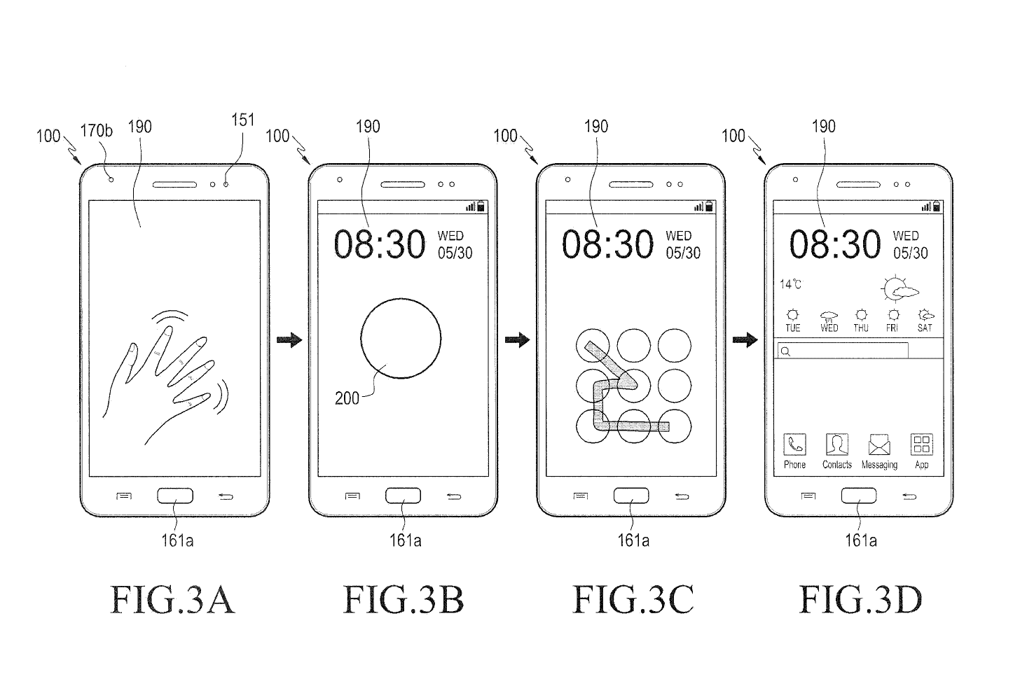

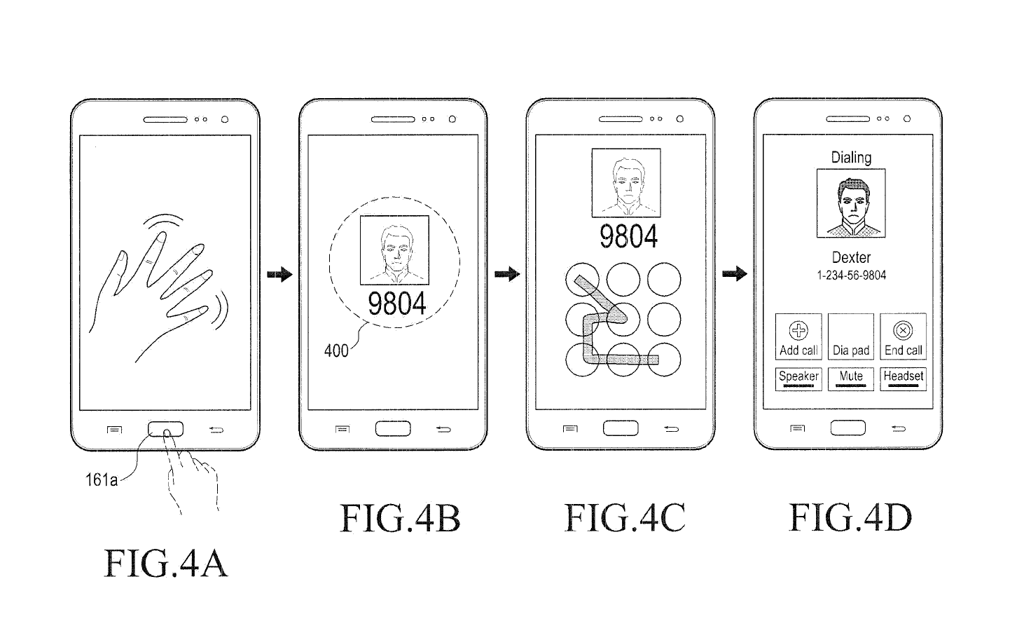

FIG. 2 is a flowchart illustrating an embodiment of a method of providing a lock screen in the portable device 100 according to an embodiment of the present disclosure. Hereinafter, a process of changing a display screen of the portable device 100 will be described in regard of examples shown in FIGS. 3A to 3D and 4A to 4D, however, the method of providing the lock screen is not limited to these examples.

Referring to FIG. 2, the controller 110 may determine whether a user input for activating the portable device 100 is detected, in a screen-off state, in operation 300.

FIGS. 3A to 3D are views for describing a method of changing a display screen of a portable device according to an embodiment of the present disclosure.

FIG. 3A shows an off screen of the portable device 100 that is in a power-on state. In the off-screen state, other user inputs except for a predetermined user input for activating the portable device 100 may be ignored.

Referring to FIG. 3A, a case of making a palm approach a proximity sensor 170b in order to activate the portable device 100 is shown, however, a user may input a predetermined command for activating the portable device 100 using any other methods. For example, the user may press one (for example, the home button 161a) of the buttons 161 of the input/output module 160, make a gesture/motion input through the camera module 150 (for example, the first camera 151), make a predetermined pattern input (for example, double tap, operation of pinching two fingers together or spreading two fingers apart on the touch screen 190, operation of drawing a circle on the touch screen 190 with a finger, etc.) on the touch screen 190, utter a voice command through the microphone 162, or input a predetermined command for activating the portable device 100 in a wireless fashion through the communication module 120.

If a user input for activating the portable device 100 is detected by one of the above-mentioned methods, the controller 110 may display a lock screen as shown in FIG. 3B, wherein the lock screen is configured with an area in which a plurality of executable objects are arranged and an information display area in which restricted information related to the objects is displayed, in operation 305. FIG. 3B briefly shows the lock screen, and the lock screen will be described in more detail, later.

Referring to FIG. 3B, the lock screen may have a display area 200 to enable a user to directly check a plurality of applications and basic information related to the applications without releasing the locked state of the portable device 100. The display area 200 may be configured to allow a user to select one of a plurality of executable objects or to navigate content or images related to the objects. On the lock screen, information to allow a user to directly check a missed call, a new message, a battery charged state, music being currently played, the time and date, etc., a plurality of objects representing a plurality of executable applications, and information related to the objects may be arranged.

The plurality of executable objects arranged on the lock screen may represent a plurality of arbitrary applications. The applications may include, for example, an SNS application, a call application, a message application, a schedule management application, a word processing application, a music application, an Internet application, a map application, a camera application, an E-mail application, a picture application, an image editing application, a search application, a file search application, a video application, and a game application. The number and kinds of the objects arranged on the lock screen may be changed according to the user's settings. For example, objects (icons) of applications that are to be displayed on a lock screen for quick execution may be set or registered in advance by the user's selection so that the user can create a user-made lock screen.

Particularly, on the display area 200, primary information which is restrictively displayed with respect to a specific object and which is irrelevant to leakage of personal information may be displayed. The primary information may be, for example, processed personal information, such as an English dictionary, public information (for example, an empty schedule list), a part of a phone number, and a part of a picture. Accordingly, when the user wants to check basic information, such as an absence message, the current time, information related to a recently executed application, etc., while at work, the user can easily check such information without releasing the lock screen.

After the lock screen is displayed, it may be determined whether a user input for releasing the lock screen is detected, in operation 310. If a user input for releasing the lock screen is detected, for example, if a user input for converting the lock screen into a home screen is detected, a home screen may be displayed, in operation 315. For example, if the home button 161a is pressed when the lock screen of FIG. 3B is displayed, a home screen as shown in FIG. 3D may be displayed on the touch screen 190. Meanwhile, before the home screen is displayed, a lock release screen as shown in FIG. 3C may be displayed in order to prevent an unauthenticated person from using the portable device 100. If no lock function has been set by the user, the lock release screen for receiving a lock release command, as shown in FIG. 3C, may be not displayed. In the current embodiment, a case in which a lock release screen for receiving a lock release command corresponding to a predetermined pattern is displayed is shown, however, any other method of authenticating a user without displaying any lock release screen, such as face recognition through the camera module 150, may be applied.

Referring to FIG. 3C, a pattern type lock release screen is shown. In this case, a movement pattern of a touch input is recognized as a lock release command, and whether to release the lock screen is determined according to the lock release command. If the lock screen is released, the home screen as shown in FIG. 3D may be displayed.

Referring to FIG. 3D, an example in which a main home screen is displayed on the touch screen 190 is shown. If the portable device 100 has different home screens of several pages, the main home screen may be the first home screen among the home screens of the pages. The home screen may display shortcut icons for executing frequently used applications, a main menu conversion key, a current time, weather information, etc. FIG. 3D shows a case in which a home screen is displayed, however, a recently used application may be loaded to display an execution screen.

If no user input for releasing the lock screen is detected in operation 310, the process may proceed to operation 320 to determine whether a user input waiting time is longer than or equal to a predetermined time. If the user input waiting time is longer than or equal to the predetermined time, the controller 110 may deactivate the portable device 100, in operation 325. Accordingly, the screen may be again turned off, and other user inputs except for a user input for activation may be ignored. That is, the current screen, for example, the lock screen or the home screen may be maintained until the user input waiting time reaches the predetermined time.

The above description relates to a series of processes that are performed until the home screen is displayed after the portable device 100 is activated. Hereinafter, screens that the portable device 100 displays when an object displayed on the lock screen of FIG. 3B and content related to the object are selected will be described with reference to FIGS. 4A to 4D.

FIGS. 4A to 4D are views for describing a method of changing a display screen of a portable device according to an embodiment of the present disclosure.

FIG. 4A shows the deactivated state of the portable device 100. In this state, if user interaction, such as making user input means for activation approach the portable device 100 or pressing the home button 161a, is detected, a lock screen having a display area 400, as shown in FIG. 4B, may be displayed. On the display area 400, information that is restrictively displayed with respect to a predetermined object may be displayed.

In FIG. 4B, a case in which a part of available contact information, such as a last call, a missed call, and a bookmark, is displayed is shown. The part of the contact information may be a part of the other party's phone number or the other party's face image. Particularly, the other party's face image may be, for example, a blurred face contour image so that only the owner of the portable device 100 can identify the other party.

If a user input for calling the other party is made on the lock screen, a lock release screen as shown in FIG. 4C may be displayed. The user input for calling the other party may be, for example, an input of touching the display area 400.

Thereafter, if a predetermined lock release command is received through the lock release screen as shown in FIG. 4C, the lock screen may be released, and then a screen according to execution of a call application may be displayed, as shown in FIG. 4D. On the screen according to the execution of the call application as shown in FIG. 4D, the other party's original image and all digits of the other party's phone number may be displayed, instead of the blurred image and the part of the phone number displayed on the lock screen of FIG. 4B.

According to the present disclosure as described above, by arranging a plurality of executable objects on a lock screen, the user can quickly execute a desired application on the lock screen, like on the home screen. Also, by displaying outline information related to the executable objects, together with the executable objects, the user can easily check object-related content recently updated.

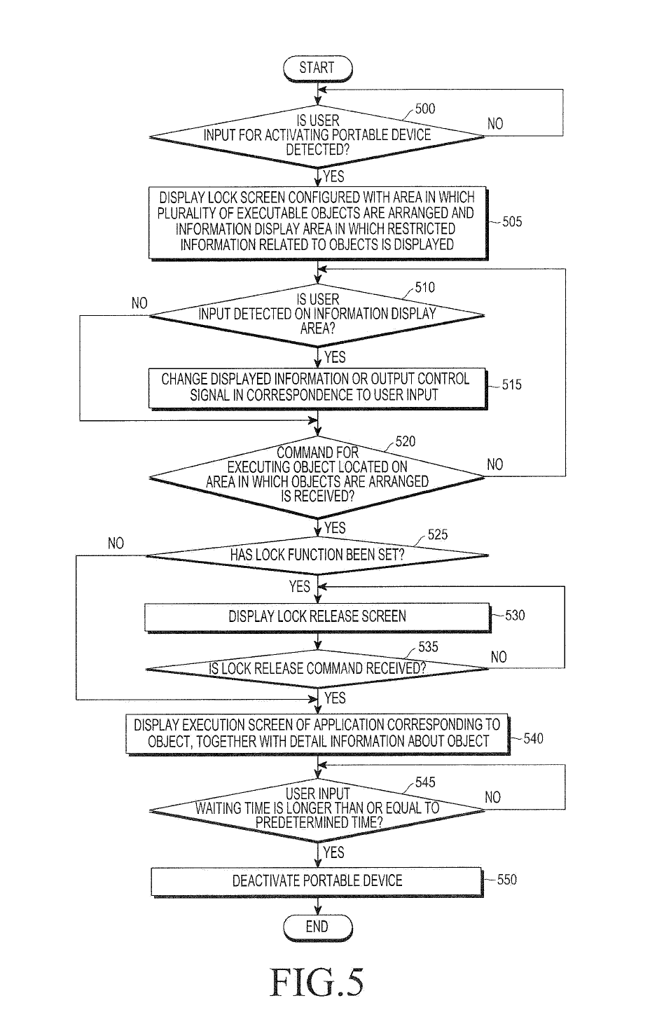

FIG. 5 is a flowchart detailedly illustrating an embodiment of a method of providing a lock screen in the portable device 100 according to an embodiment of the present disclosure.

Referring to FIG. 5, operations 500 and 505 are the same as operations 300 and 305 of FIG. 2, and accordingly, a detailed description thereof will be omitted.

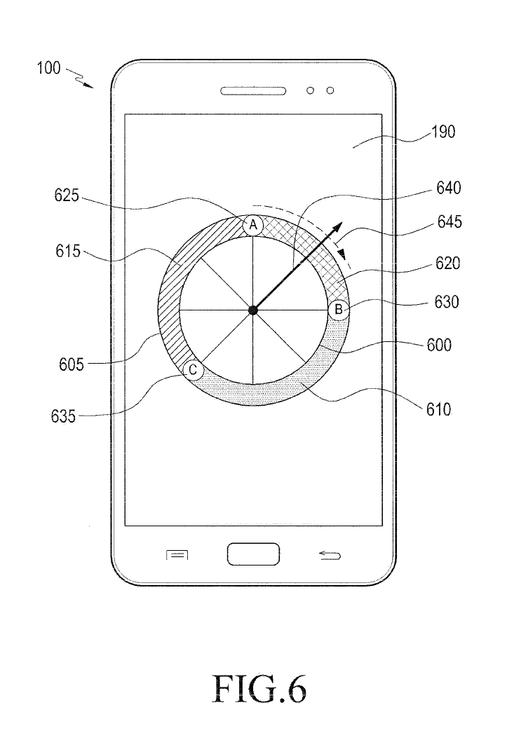

FIG. 6 is a view for describing a configuration of a lock screen according to an embodiment of the present disclosure.

Referring to FIG. 6, the lock screen may be largely divided into an area 605 in which a plurality of executable objects are arranged, and a restricted information display area 600 on which restricted information related to the objects is displayed. In FIG. 6, a case in which the information display area 600 is in the shape of a circle, and the area 605 in which the objects are arranged is in the shape of a ring, like a doughnut, surrounding the information display area 600 in the shape of the circle is shown. However, the information display area 600 may have any other shape, such as an oval shape, a rectangle shape, and a square shape. Also, the objects may be arranged in the shape of a bar, or in the shape of a matrix consisting of rows and columns such that the objects are spaced apart from each other. Also, the objects may be arranged randomly.

Also, on the information display area 600, primary information, such as a part of text and a part of available images, which are irrelevant to personal information, may be displayed. On the area 605 in which the objects are arranged, one or more objects 625, 630, and 635 that are shortcut icons for executing predetermined applications may be arranged. At least some of the objects may be displayed to include at least one of an image and text. The image may be a character or a symbol for representing or easily identifying an application of the corresponding object, or may be text such as logo. The object may include a title to describe a feature of the object, in the form of text for identifying the object.

Also, areas 610, 615, and 620 positioned between the objects in the area 605 in which the objects are arranged may be used to represent the states of data related to the corresponding objects. For example, on the areas 610, 615, and 620 positioned between the objects, the amount of data stored for each application, the number of new data, a memory state, etc. may be represented as the states of data by differentiating colors, brightness levels, etc.

In the current embodiment, a user input made on the information display area 600 may be considered as an input for changing information that is displayed on the information display area 600. Also, a user input made on the object 625, 630, or 635 may be considered as an input for executing an application of the corresponding object.

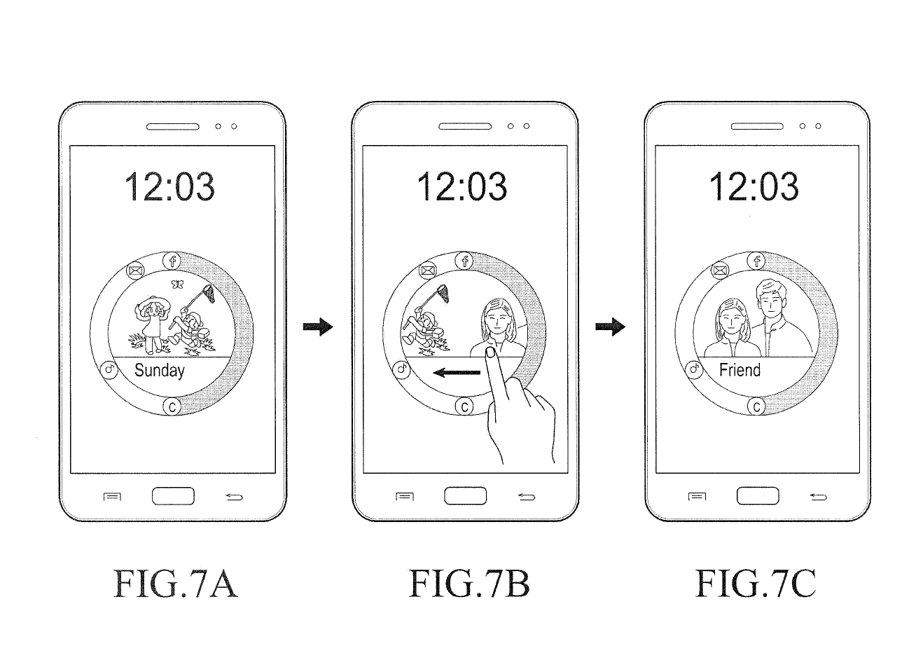

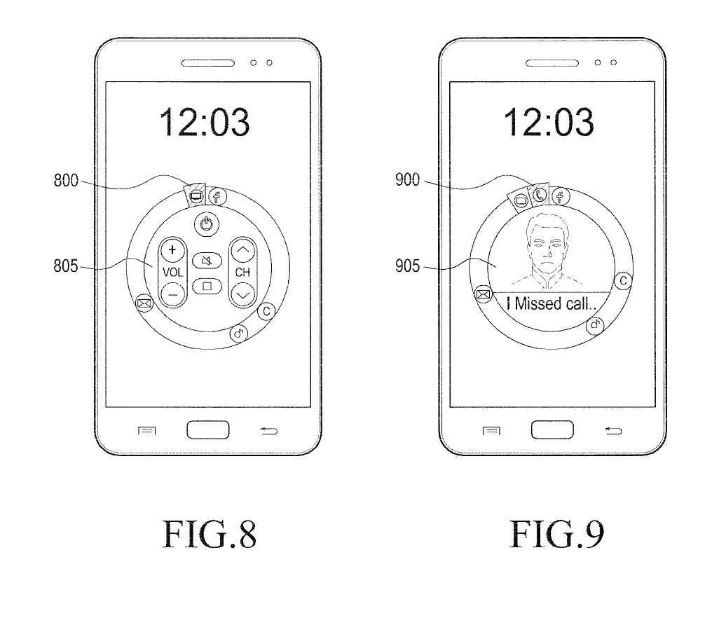

Accordingly, when the lock screen is displayed, the controller 110 may determine whether a user input is detected on the information display area 600, in operation 510. If the controller 110 determines that a user input, for example, a touch input or a touch-and-drag input is detected on the information display area 600, the controller 110 may change information displayed on the information display area 600, in correspondence to the user input, or may output a control signal corresponding to the user input. Operation that is performed when a user input is detected on the information display area 600 will be described with reference to FIGS. 7A to 7D and 8, below.

FIGS. 7A to 7C are views for describing a method of changing a display of object information on a lock screen, according to an embodiment of the present disclosure.

In FIG. 7A, a case in which a logo image f for easily identifying an SNS application (for example, Facebook) and an image related to the SNS application are displayed on an information display area of a lock screen is shown. FIG. 7B shows a screen appearing when a gesture of touching and dragging the image displayed on the information display area of the lock screen is made. After the touch-and-drag gesture is made, another image as shown in FIG. 7C may be displayed. The other image may be preferably an image set to “Open to All” in the SNS application. Likewise, if a user input is detected when text instead of an image is displayed on the information display area, the content of the text may be changed to the content of another text.

FIGS. 8 to 13 show configuration examples of lock screens according to various applications, according to various embodiments of the present disclosure.

In FIG. 8, a case in which an object 800 is displayed as a TV-shaped icon on an area on which objects are arranged, and a remote controller image is displayed on an information display area 805 is shown. Accordingly, a user input made on the information display area 805 may be considered as a control signal corresponding to a remote controller button to be used to control a TV.

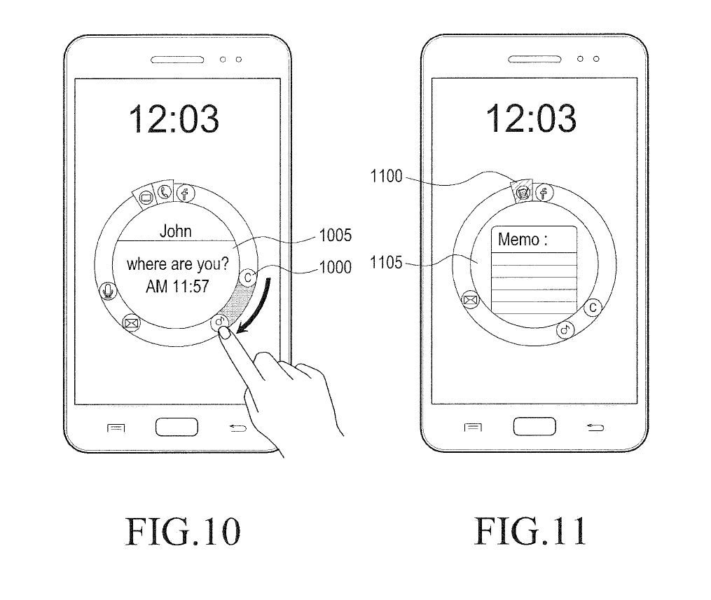

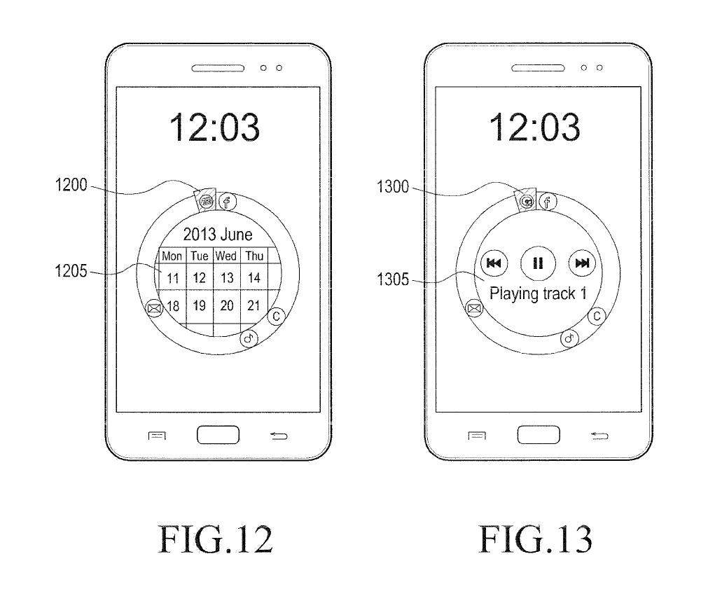

However, in addition to the above-described configurations, the lock screen may have other various configurations as shown in FIGS. 9 to 13. In FIG. 9, a case in which a phone-shaped object 900 corresponding to a call application is displayed on an area in which objects are displayed, and outline information related to the call application is displayed on an information display area 905 is shown. In FIG. 9, the phone-shaped object 900 may be linked to the call application in order to execute the call application. In FIG. 10, a case in which an object 1000 of a title representing chatting of an interactive SNS application is displayed on an area in which objects are displayed, and the content of the chatting is displayed on an information display area 1005 is shown. In FIG. 11, a case in which a memo-shaped object 1100 linked to a memo application is displayed on an area in which objects are displayed, and a memo window is displayed on an information display area 1105 is shown. In FIG. 12, a case in which a calendar-shaped object 1200 is displayed on an area in which objects are displayed, and a calendar is displayed on an information display area 1205 is shown. In FIG. 13, a case in which an object 1300 representing a music application is displayed on an area in which objects are displayed, and music-related buttons and music-related content are displayed on an information display area 1305 is shown.

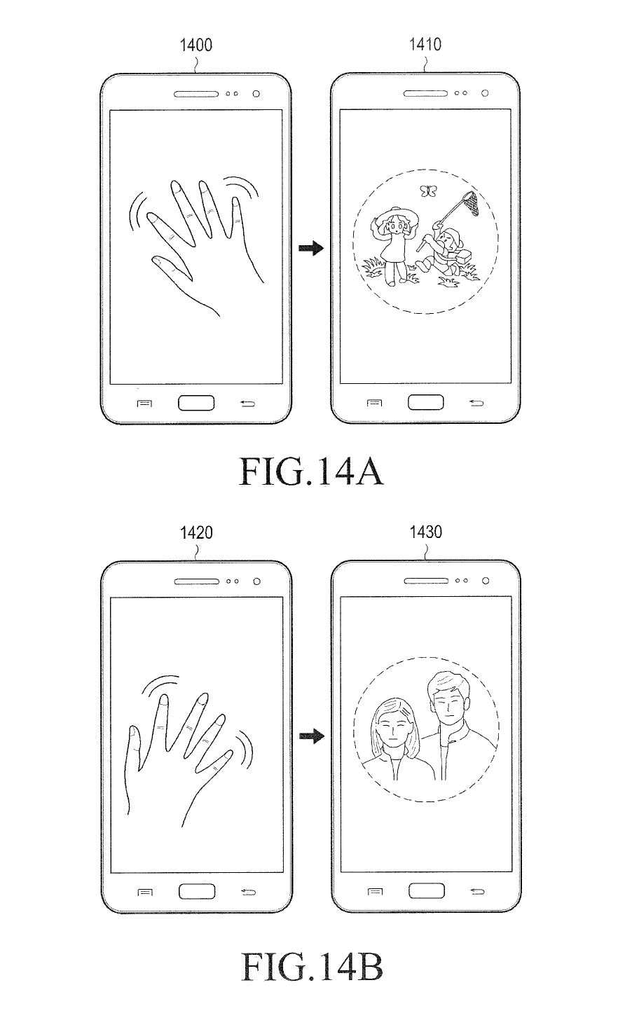

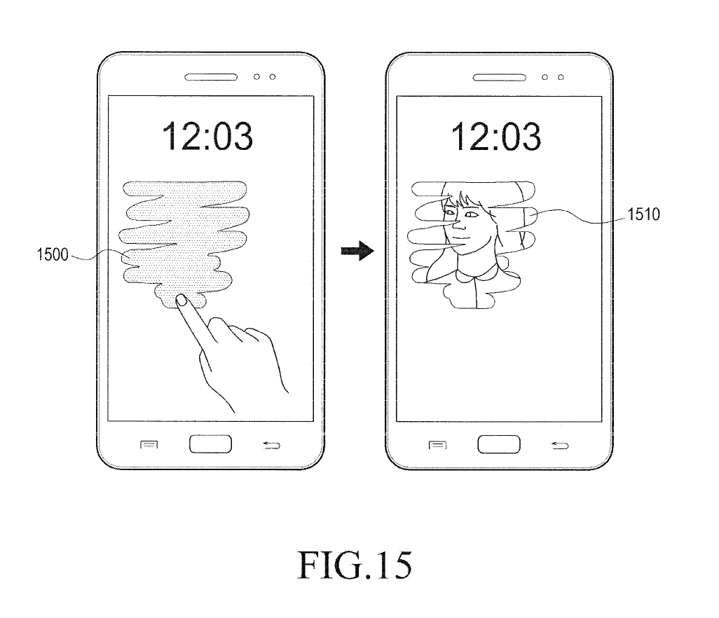

Meanwhile, content that is displayed on the information display area may be changed by a predetermined method which will be described with reference to FIGS. 14A and 14B to 15, below.

FIGS. 14A and 14B show examples of screens for describing an interaction method for outputting a lock screen in a screen-off state, according to an embodiment of the present disclosure.

For example, referring to FIG. 14A, if a user input for activation is detected after a deactivation screen 1400 of the portable device 100 is displayed, a lock screen 1410 may be displayed. Then, if another user input for activation is detected after a deactivation screen 1420 is displayed, a lock screen 1430 of new content may be displayed, as shown in FIG. 14B. As such, whenever user interaction occurs, information that is displayed on a lock screen may change. The information may be frequently changing data, such as, for example, weather, a picture, and stocks.

FIG. 15 shows examples of screens for describing an interaction method for outputting a lock screen in a screen-off state, according to an embodiment of the present disclosure.

In FIG. 15, a case in which information 1510 is displayed to correspond to an area 1500 touched by a user is shown. In this case, the user can see information of his/her desired size.

Meanwhile, if no user input is detected on the information display area in operation 510, or if information displayed on the information display area changes or a control signal is output in operation 515, the controller 110 may determine whether a command for executing an object located on the area in which the objects are arranged is received, in operation 520.

In order to execute an application related to an object, the user may use, as shown in FIG. 6, user input means such as a finger or a stylus pen to touch an object A for a predetermined time and then drag the object A to the location of the next object, object B, in a clockwise direction (645). Alternatively, the user may perform operation of dragging his/her finger outward from the center of the circle area until the finger gets out of the area in which the objects are arranged (640). In this case, an application corresponding to an object that is in an activated state may be executed. The object that is in the activated state may be an object displayed in a selectable state when a user input is generated by user input means. In the current embodiment, a touch-and-drag operation has been described as an example of an object execution command, however, other various methods such as touching an object for a predetermined time or more may be applied.

If an object execution command as described above is received, it may be determined whether the lock function has been set, in operation 525. If it is determined that the lock function has been set, a lock release screen may be displayed in operation 530, and then it may be determined whether a lock release command is received, in operation 535. If a lock release command is received, an execution screen of an application corresponding to the object may be displayed, together with detail information about the object, in operation 540. Meanwhile, if it is determined in operation 525 that no lock function has been set, operations 530 and 535 may be omitted. Operations 545 and 550 are the same as operations 320 and 325 of FIG. 2 as described above, and accordingly, a detailed description thereof will be omitted.

Various embodiments of the present disclosure may be implemented in the form of hardware, software, or a combination of hardware and software. The software may be stored in a volatile or non-volatile memory device such as, for example, a ROM, regardless of whether it is erasable or re-writable, in a memory such as, for example, a RAM, a memory chip, and an integrated circuit (IC), or in an optically/magnetically recordable and machine-readable storage medium such as, for example, a CD, a digital versatile disc (DVD), a magnetic disk, and a magnetic tape. A memory that can be included in a portable device is an example of a non-transitory machine-readable storage medium suitable to store one or more programs, including instructions implementing embodiments of the present disclosure. Therefore, embodiments of the present disclosure include programs including codes for implementing the devices and methods as set forth in the appended claims of the specification, and a non-transitory machine-readable storage medium storing these programs. These programs may be electronically transferred through any media and equivalents thereof, such as communication signals, which are transferred through wired or wireless connections.

Also, the portable device may receive and store the programs from a program providing apparatus connected in a wired/wireless fashion. The program providing apparatus may include a memory for storing a program, etc. including instructions for performing a method of controlling a display of a plurality of objects according to a motion of the portable device, a communication unit for performing wired/wireless communication with the portable device, and a controller for transmitting the program to the portable device according to a request from the portable device or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method of providing a lock screen in a portable device, the method comprising:
detecting a user input for activating the portable device; and
displaying, if the user input is detected, a lock screen configured with a plurality of executable objects and an information display area having a restricted viewing range with respect to at least one executable object of the plurality of executable objects.

2. The method of claim 1, further comprising, if one executable object among the plurality of executable objects is selected, executing an application linked to the selected object.

3. The method of claim 2, wherein the executing of the application linked to the selected executable object comprises, if one executable object among the plurality of executable objects is touched and then dragged in a predetermined direction, executing an application linked to the touched executable object.

4. The method of claim 1, further comprising, if the user input is made on the information display area, changing information displayed on the information display area and displaying the changed information, according to the user input.

5. The method of claim 4, wherein the information displayed on the information display area is information that is restrictively displayed with respect to the at least one executable object among the plurality of executable objects.

6. The method of claim 1, further comprising:
determining, if one executable object among the plurality of executable objects is selected, whether a lock function has been set; and
displaying, if it is determined that the lock function has been set, a lock release screen for receiving a lock release command.

7. The method of claim 6, further comprising, if a predetermined lock release command is input on the lock release screen, displaying an execution screen of an application linked to the selected executable object, together with detail information about the selected executable object.

8. The method of claim 1, further comprising, if a user input for releasing the lock screen is detected on the lock screen, displaying a previous executable object execution screen or a home screen.

9. The method of claim 1, wherein the plurality of executable objects include at least one among shortcut icons for executing applications, widgets, icons representing documents with specific file formats, pictures, and folders.

10. The method of claim 1, wherein the detecting of the user input comprises detecting whether a user input means approaches the portable device, through a proximity sensor of the portable device.

11. A portable device for providing a lock screen, the portable device comprising:
a controller configured to control, if a user input for activating the portable device is detected, a display of a lock screen including at least one executable object and restricted information having a restricted viewing range among information about the executable object; and
a display unit configured to display the lock screen.

12. The portable device of claim 11, further comprising:
a sensor module configured to detect whether a user input means approaches the portable device,
wherein the controller is further configured to detects a user input for activating the portable device, based on a signal detected by the sensor module.

13. The portable device of claim 11, further comprising:
an input/output module configured to receive a user input for activating the portable device,
wherein the controller is further configured to detects the user input through the input/output module.

14. The portable device of claim 11, wherein the restricted information having the restricted viewing range among the information about the executable object is information of an upper level that is able to be identified by an owner of the portable device.

15. The portable device of claim 11, wherein, if the at least one executable object is selected on the lock screen, the controller is further configured to executes an application linked to the selected executable object.

16. The portable device of claim 15, wherein, if the at least one executable object is touched and dragged on the display unit, the controller is further configured to executes an application linked to the executable object.

17. The portable device of claim 11, wherein, if the user input is detected on a predetermined area in which the restricted information is displayed, the controller is further configured to:
changes the restricted information displayed on the predetermined area, and
displays the changed information on the predetermined area, according to the user input.

18. The portable device of claim 17, wherein the information displayed on the predetermined area is information that is restrictively displayed with respect to the executable object.

19. The portable device of claim 11, wherein, if the executable object is selected, the controller is further configured to determines whether a lock function has been set, and if the controller determines that the lock function has been set, the controller is further configured to controls the display unit to display a lock release screen for receiving a lock release command.

20. The portable device of claim 19, wherein, if a predetermined lock release command is input on the lock release screen, the controller is further configured to controls the display unit to display an execution screen of an application linked to the selected executable object, together with detail information about the executable object.

21. The portable device of claim 11, wherein, if a user input for releasing the lock screen is detected on the lock screen, the controller is further configured to controls the display unit to display a previous executable object execution screen or a home screen.

22. The portable device of claim 11, wherein the at least one executable object includes at least one among shortcut icons for executing applications, widgets, icons representing documents with specific file formats, pictures, and folders.

23. The portable device of claim 17, wherein the user input comprises a circular user input.

24. The method of claim 4, wherein the user input comprises a circular user input.
